(19) United States
(12) Patent Application Publication
(10) Pub. No.: US 2026/0237211 A1
(43) Pub. Date: Aug. 13, 2026

(54) VIDEO CUT DETECTION

(71) Applicant: InterDigital CE Patent Holdings, SAS, Paris (FR)

(72) Inventors: Laurent Cauvin, CHEVAIGNE (FR); Frederic Plissonneau, Thorigne-Fouillard (FR); Patrick Lopez, Livre sur Changeon (FR); David Touze, RENNES (FR)

(21) Appl. No.: 19/151,903

(22) PCT Filed: Jan. 23, 2024
(86) PCT No.: PCT/EP2024/051568

§ 371 Date: Jul. 29, 2025

(30) Foreign Application Priority Data
Jan. 31, 2023 (EP) 23305120.0

(51) Int. Cl. G06V 20/40; G06V 10/50

(52) U.S. Cl. CPC G06V 20/49; G06V 10/50

(57) ABSTRACT

A method comprising: obtaining (700) two consecutive pictures of a video sequence; computing (701) a first histogram of a first of the two consecutive pictures and a second histogram of a second of the two consecutive pictures; computing (702) a first information, the first information being a number of bins for which an absolute value of a difference between a first value representative of a number of samples represented by a bin of the first histogram and a second value representative of a number of samples represented by a corresponding bin of the second histogram is higher than a third value; performing (703) a first comparison comparing the first information to a fourth value; and, identifying (705) a scene cut between the two pictures in function of a result of the first comparison.

### 1. CROSS REFERENCE TO RELATED APPLICATIONS

This application claims priority to European Application No. 23305120.0, filed Jan. 31, 2023, which is incorporated herein by reference in its entirety.

### 2. TECHNICAL FIELD

At least one of the present embodiments generally relates to the field of production of video and more particularly to a method, a device and a system for detecting cuts in a video.

### 3. BACKGROUND

A scene is defined as a sequence of successive video pictures captured with one continuous operation of one capture device. A video program is a succession of scenes.

Some effects or processing can then be applied to the video program. It often happens that the characteristics or settings of these effects or processing depend on the content itself. For example, these settings can depend on an average luminance of the pictures, or on some characteristics of their histogram, an histogram being a representation of a statistical distribution of luminance values or of the color values of samples of a picture. As these characteristics are generally consistent during a whole scene, it is necessary to be able to detect scene cuts between two consecutive scenes to be able to correctly set the processing to be applied.

Many automatic scene detection methods are available in the literature.

However, these methods may be subject to false detections, i.e. erroneous detections of a scene cut. Frequent false detection may be an issue, in particular since it implies an update of parameters of all process the parameters of which are adapted to the content and therefore increases the computation complexity and the energy consumption. In addition, frequent updates of parameters may increase a risk of flickering in the video.

It is desirable to overcome the above drawbacks.

It is particularly desirable to propose a method limiting false detections of scene cuts.

### 4. BRIEF SUMMARY

In a first aspect, one or more of the present embodiments provide a method comprising:
obtaining two consecutive pictures of a video sequence;
computing a first histogram of a first of the two consecutive pictures and a second histogram of a second of the two consecutive pictures; computing a first information, the first information being a number of bins for which an absolute value of a difference between a first value representative of a number of samples represented by a bin of the first histogram and a second value representative of a number of samples represented by a corresponding bin of the second histogram is higher than a third value; performing a first comparison comparing the first information to a fourth value; and, identifying a scene cut between the two pictures in function of a result of the first comparison.

In an embodiment, each value representative of a number of samples is a non-linear function of a number of samples.

In an embodiment, the method further comprises computing a second information as a sum of the differences for which the absolute value of the difference is higher than the third value and performing a second comparison comparing the second information to a fifth value, the scene cut being further identified based on a result of the second comparison.

In an embodiment, responsive to one of the first and second comparison indicates a scene cut while the other one of the first and second comparison indicates no scene cut, a confirmation process based on a third comparison comparing the first information to a confidence range around the fourth value and on a fourth comparison comparing the second information to a confidence range around the fifth value is applied to confirm a presence of a scene cut.

In a second aspect, one or more of the present embodiments provide a device comprising electronic circuitry configured for: obtaining two consecutive pictures of a video sequence; computing a first histogram of a first of the two consecutive pictures and a second histogram of a second of the two consecutive pictures; computing a first information, the first information being a number of bins for which an absolute value of a difference between a first value representative of a number of samples represented by a bin of the first histogram and a second value representative of a number of samples represented by a corresponding bin of the second histogram is higher than a third value; performing a first comparison comparing the first information to a fourth value; and, identifying a scene cut between the two pictures in function of a result of the first comparison.

In an embodiment, each value representative of a number of samples is a non-linear function of a number of samples.

In an embodiment, the electronic circuitry is further configured for computing a second information as a sum of the differences for which the absolute value of the difference is higher than the third value and performing a second comparison comparing the second information to a fifth value, the scene cut being further identified based on a result of the second comparison.

In an embodiment, responsive to one of the first and second comparison indicates a scene cut while the other one of the first and second comparison indicates no scene cut, the electronic circuitry is further configured to apply a confirmation process based on a third comparison comparing the first information to a confidence range around fourth value and on a fourth comparison comparing the second information to a confidence range around the fifth value to confirm a presence of a scene cut.

In a third aspect, one or more of the present embodiments provide a non-transitory information storage medium storing program code instructions for implementing the method according to the first aspect.

In a fourth aspect, one or more of the present embodiments provide a computer program comprising program code instructions for implementing the method according to the first aspect.

### 5. BRIEF SUMMARY OF THE DRAWINGS

FIGS. 1 to 4 provide examples of histograms of two consecutive pictures;

FIG. 5 illustrates schematically a context in which embodiments are implemented;

FIG. 6A illustrates schematically an example of hardware architecture of a processing module able to implement various aspects and embodiments;

FIG. 6B illustrates a block diagram of an example of a first system in which various aspects and embodiments are implemented;

FIG. 6C illustrates a block diagram of an example of a second system in which various aspects and embodiments are implemented;

FIG. 7 illustrates schematically a method for identifying a scene cut in a video;

FIG. 8 illustrates a detail of the method for identifying a scene cut in a video; and,

FIG. 9 illustrates an additional embodiment of the method for identifying a scene cut in a video.

### 6. DETAILED DESCRIPTION

Histograms, such as the histogram of luminance values, are often used to characterize a picture (or image). Note that in the following the expressions “picture” and “image” are used in an interchangeable manner. To construct an histogram, the first step is to divide an entire range of values into a series of intervals called bins and then to count how many values fall into each bin. The bins are considered here to be adjacent and of equal size. For example, if luminance values of an incoming picture are coded on “8” bits, an histogram of a picture can be constructed using “4” bins: bin “0” counts the luminance values in the range [0 . . . 63]; bin “1” counts the luminance values in the range [64 . . . 127], bin “2” counts the luminance values in the range [128 . . . 191], and bin “3” counts the luminance values in the range [192 . . . 255]. Other number of bins can be used. For instance, for a picture with luminance values coded on “8” bits, the picture can be represented by an histogram of luminance values of “256” bins: each bin i in the range [0 . . . 255] counts the number of samples in the picture having the luminance value i.

Histogram difference-based methods are generally used for video cut detection, since they are fast, accurate and very effective. A cut is declared to be detected when a difference, or a distance, between the histograms of two consecutive pictures is higher than a given threshold. Following are examples of such histogram difference-based methods. In these examples, histograms h1 and h2 are normalized (i.e. all the bins are divided by the sum of the bins: as a consequence, the sum of all the bins of the resulting normalized histogram is equal to “1”), and bins at the same position in both histograms have the same size. In addition, N is the number of bins in the histogram:

### 1. Sum of the Absolute Values of the Difference of Bins:

$$d = {\sum }_{i = 1}^{N} \vert h 1 [ i ] - h 2 [ i ] \vert$$

### 2. Intersection of Histograms:

$$d = 1 - {\sum }_{i = 1}^{N} min ( h 1 [ i ] , h 2 [ i ] )$$

### 3. Correlation of Histograms:

$$d = {\sum }_{i = 1}^{N} ( h 1 [ i ] - \frac{1}{N} ) ( h 2 [ i ] - \frac{1}{N} ) {/ [ {\sum }_{i = 1}^{N} {( h 1 [ i ] - \frac{1}{N} )}^{2} {\sum }_{i = 1}^{N} {( h 2 [ i ] - \frac{1}{N} )}^{2} ]}^{1 / 2}$$

Note that, as histograms are normalized, 1/N is the mean of the histogram.

### 4. Chi-2:

$$d = {\sum }_{i = 1}^{N} \frac{{( h 1 [ i ] - h 2 [ i ] )}^{2}}{h 1 [ i ] + h 2 [ i ]}$$

### 5. Bhattacharyya:

$$d = {( 1 - {\sum }_{i = 1}^{N} h {1 [ i ]}^{0.5} h {2 [ i ]}^{0.5} )}^{0.5}$$

When two consecutive frames are quite similar, the distance is close to zero, whatever the method. The distance must be compared against a threshold to detect if two consecutive frames are different.

It must be noted that the following distance:

$$d = {\sum }_{i = 1}^{N} h 1 [ i ] - h 2 [ i ]$$

does not work. As both histograms are normalized, the result of the equation above is always “0” whatever the content of both histograms.

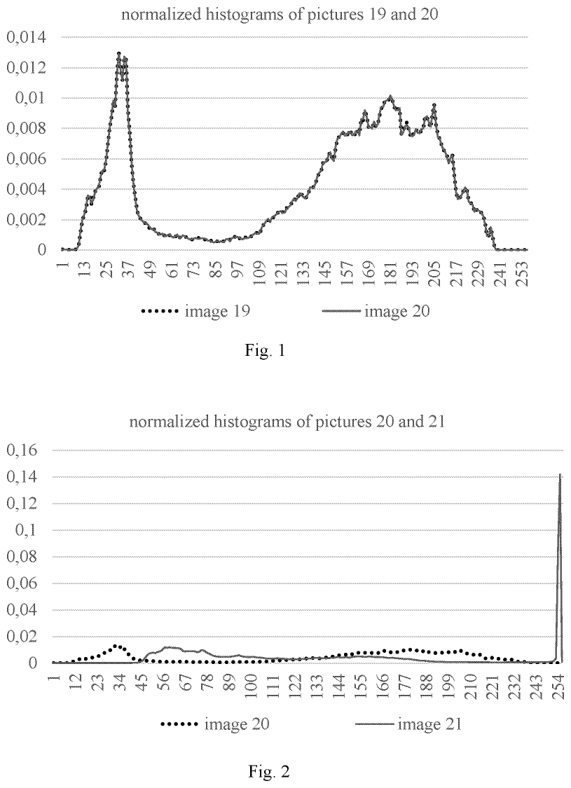

FIG. 1 provides an example of histograms of two consecutive pictures numbered “19” and “20”. The two histograms a nearly identical. Table TAB1 gives results of cut detection using the different distances. As can be seen, the value of each distance is very low.

TABLE TAB1

| | |
|---|---|
| sum of absolute | 0.011306 |
| differences | |
| intersection | 0.005653 |
| correlation | 0.000159 |
| chi 2 | 0.000194 |
| Bhattacharyya | 0.009568 |

FIG. 2 provide an example of histograms of two consecutive pictures numbered “20” and “21”. The two histograms have strong differences with for instance a high peak of luminance values in picture “21” around “254”. Table TAB2 gives results of cut detection using the different distances. As can be seen, the value of each distance is much higher than in table TAB1.

TABLE TAB2

| | |
|---|---|
| sum of absolute | 1.283675 |
| differences | |
| intersection | 0.641837 |
| correlation | 1.178864 |
| chi 2 | 0.597448 |
| Bhattacharyya | 0.633111 |

Table TAB3 aggregates minimum, maximum and average values of the distances computed using the “5” scene detection methods when applied on a video comprising “70” different scenes. In this video, the content of the successive scenes differs considerably most of the time:

TABLE TAB3

| | Min | Max | Average |
|---|---|---|---|
| | value | value | value |
| sum of absolute | 0.382 | 1.722 | 0.934 |
| differences | | | |
| intersection | 0.191 | 0.861 | 0.467 |
| correlation | 0.095 | 1.626 | 0.833 |
| chi 2 | 0.160 | 1.271 | 0.571 |
| Bhattacharyya | 0.206 | 0.805 | 0.436 |

Table TAB4 shows the distances computed using the “5” scene detection methods when applied on a video comprising “5” scene cuts (cut “9”, cut “10”, cut “15”, cut “19” and cut “32”) difficult to detect since the contents of the scenes are very close:

TABLE TAB4

| | cut 9 | cut 10 | cut 15 | cut 19 | cut 32 |
|---|---|---|---|---|---|
| sum of absolute | 0.395047 | 0.668901 | 0.721929 | 0.156466 | 0.375661 |
| differences | | | | | |
| intersection | 0.197524 | 0.33445 | 0.360964 | 0.078233 | 0.18783 |
| correlation | 0.294147 | 0.654908 | 0.618888 | 0.013388 | 0.172473 |
| chi 2 | 0.123276 | 0.263983 | 0.368478 | 0.035361 | 0.091886 |
| Bhattacharyya | 0.191818 | 0.264657 | 0.330439 | 0.103197 | 0.154695 |

The values for the much challenging cut (cut 19) (in table TAB4) are all lower than the ones of the “min value” column in the table TAB3 even if real scene cut exist. For the Bhattacharyya distance for example, the distance values in this set of cut samples goes from “0.10” to “0.33”, and “3” distances are under the min value of the tableTAB3. Then choosing “0.1” as a threshold for the Bhattacharyya distance (and more generally a value close to the one of the column “cut 19” for each distance method) seems to be a correct value if we want to detect a maximum of cuts.

Nevertheless, there are some cases where all these distances fail, especially when one (or some) high level bin (i.e. bins associated to a high number of samples) shifts from one position to a close position in two consecutive frames. This is obviously not a scene cut (a human eye doesn't detect a scene cut, and generally doesn't even notice any change) even if all distances erroneously detect a scene cut. This is what is called a false detection or false cut.

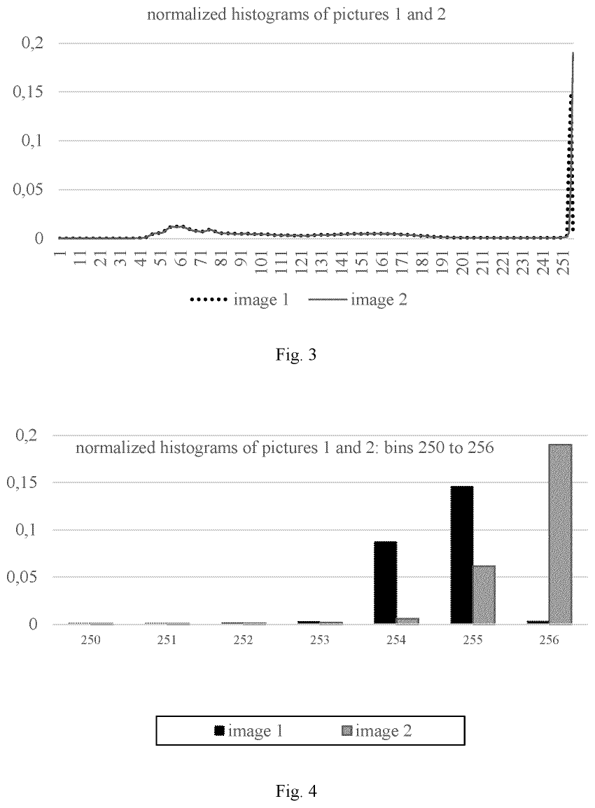

FIG. 3 provides an example of two histograms, the histogram of a picture “1” showing a peak around the luminance values “254” and “255” while the histogram of picture “2” shows the same peak but around the luminance value “256”.

FIG. 4 provides the same example as table FIG. 3 but with a zoom on values between “250” and “256”.

We can see that both histograms are globally very close, except for bins “254”, “255” and “256” where values have shifted. The consequence is that all the distances are not close to zero as reflected in table TAB5:

TABLE TAB5

| | |
|---|---|
| sum of absolute | 0.375011 |
| differences | |
| intersection | 0.187505 |
| correlation | 0.694425 |
| chi 2 | 0.286479 |
| Bhattacharyya | 0.324149 |

Moreover, the values of the distances in table TAB5 are in the same range as the value of the distances of the “true” scene cuts described above. For example, the Bhattacharyya distance is “0.32”, which is higher than four of the five “true” scene cut distances shown in the example above for example for cut9, cut10, . . . , cut32.

As can be seen, current scene cut detection methods generally detect a scene cut when the content of a bin of an histogram is just displaced to another bin or group of bins. This can happen when the luminance of a source of light with a given surface (as low as 3% of the complete picture, depending on the threshold chosen to trigger the scene cut detection) suddenly changes in the next picture.

The false cut detection described above happens because all the defined distances use comparisons of bins with identical index (index i of a first histogram is compared to index i of a second histogram). The result of all comparisons is then summed.

In the following embodiment, two properties of the false scene cut detection are used:
The bins which are not concerned by the bin shift remain quite constant between two consecutive pictures (i.e., the histogram remains constant except at the bin position(s) concerned by the shift).
The bin(s) which triggers the false scene cut detection varies a lot from a picture to another by definition.

These properties are used to derive new methods for identifying scene cuts.

A first embodiment consists in counting a number of absolute values of bin differences higher than a small threshold to detect scene cuts.

A second embodiment uses the following observations. Knowing that a sum of bin differences between two normalized histograms is zero, calculating the sum of the differences of bins of two normalized histograms higher than a small threshold also produces a result close to zero. In addition, applying a non-linear function such as the square root function to each bin before doing the sum of differences of bins when the absolute value of these differences is higher than a small threshold, and counting these differences, allows discriminating false scene from true scene cuts. Indeed, for false scene cuts, the number of these differences as well as their sum is close to zero. For true scene cuts, the number of these differences as well as their sum is not close to zero.

Both embodiments and their variants can be used alone or together.

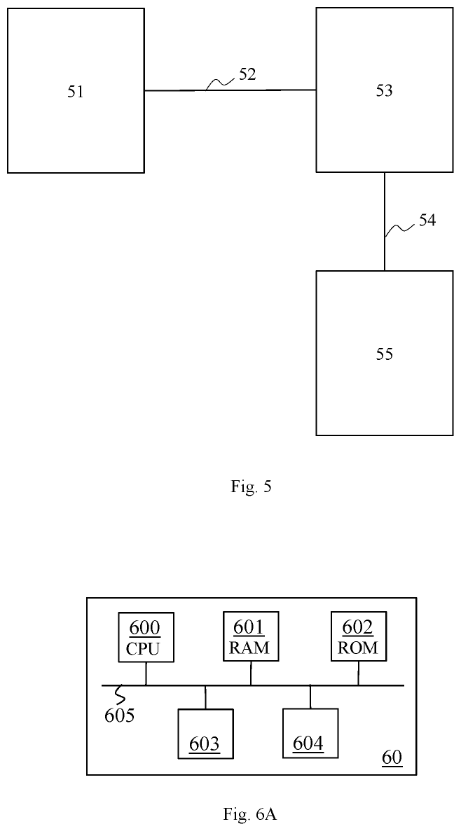

FIG. 5 illustrates schematically a context in which embodiments are implemented.

In FIG. 5, a system 51, that could be a camera, a storage device, a computer, a server or any device capable of delivering video data, transmits video data to a system 53 using a communication channel 52. The video data are either encoded and transmitted by the system 51 or received and/or stored by the system 51 and then transmitted. The communication channel 52 is a wired (for example Internet or Ethernet) or a wireless (for example WiFi, 3G, 4G or 5G) network link.

The system 53, that could be for example a set top box, receives and decodes the video stream to generate a sequence of decoded pictures. A post-processing is applied to the decoded pictures.

The obtained sequence of decoded pictures is then transmitted to a display system 55 using a communication channel 54, that could be a wired or wireless network. The display system 55 then displays said pictures.

In an embodiment, the system 53 is comprised in the display system 55. In that case, the system 53 and display system 55 are comprised in a TV, a computer, a tablet, a smartphone, a head-mounted display, etc.

In the example of FIG. 5, the post-processing is adapted to the content of the decoded video data. However, in order to limit the computations performed by the system 53, post-processing parameters are updated only after a scene cut. Post-processing parameters are supposed therefore adapted to all pictures of a scene. A post processing process is for example a filtering process for reducing a noise in a scene, a edge detection process comprised in an edge improvement process, a film grain process, etc.

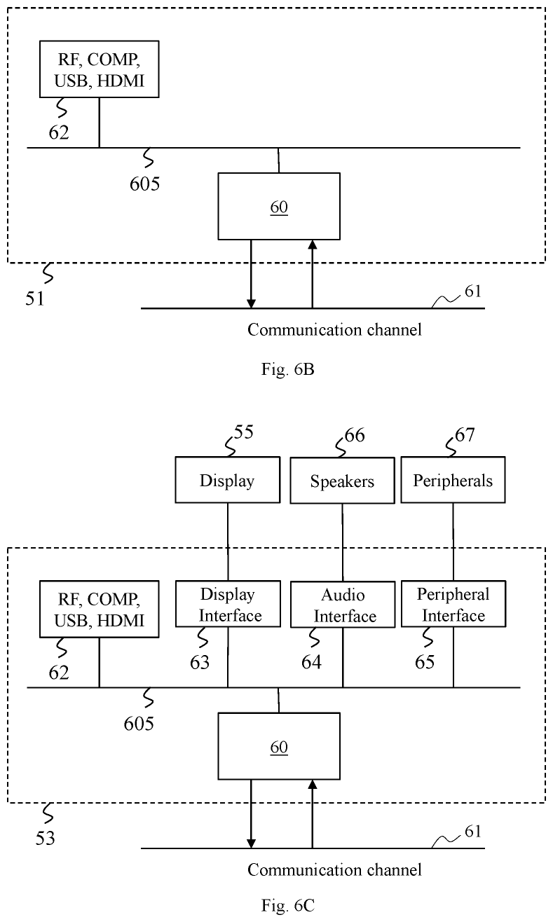

FIG. 6A illustrates schematically an example of hardware architecture of a processing module 60 comprised at least in the system 51 or in the system 53.

The processing module 60 comprises, connected by a communication bus 605: a processor or CPU (central processing unit) 600 encompassing one or more microprocessors, general purpose computers, special purpose computers, and processors based on a multi-core architecture, as non-limiting examples; a random access memory (RAM) 601; a read only memory (ROM) 602; a storage unit 603, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive, or a storage medium reader, such as a SD (secure digital) card reader and/or a hard disc drive (HDD) and/or a network accessible storage device; at least one communication interface 604 for exchanging data with other modules, devices, systems or equipment. The communication interface 604 can include, but is not limited to, a transceiver configured to transmit and to receive data over a communication network 61 (not represented in FIG. 6A). The communication interface 604 can include, but is not limited to, a modem or a network card.

For example, the communication interface 604 enables the processing module 60 to receive a SDR video content in a first format and to output a SDR video content in a second format.

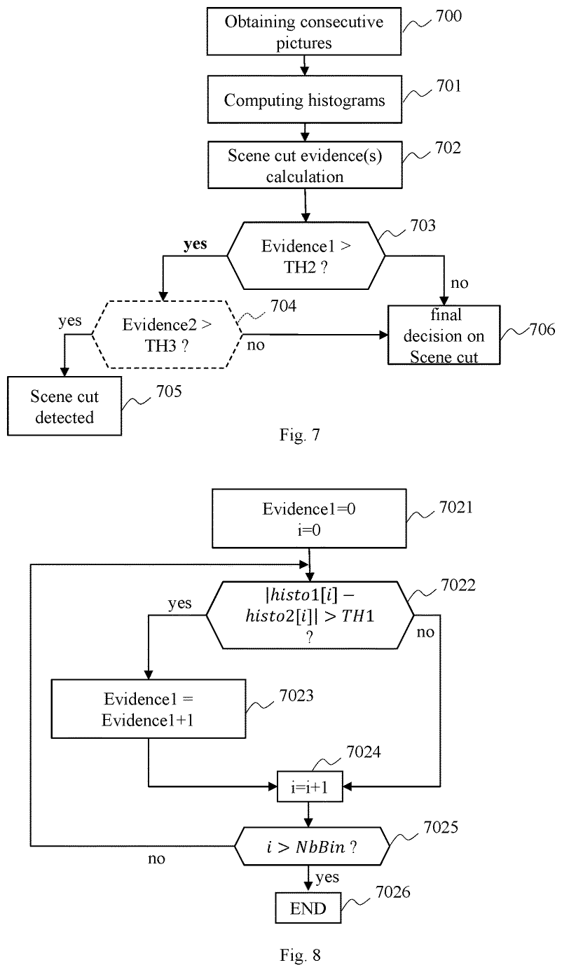

The processor 600 is capable of executing instructions loaded into the RAM 601 from the ROM 602, from an external memory (not shown), from a storage medium, or from a communication network. When the processing module 60 is powered up, the processor 600 is capable of reading instructions from the RAM 601 and executing them. These instructions form a computer program causing, for example, the implementation by the processor 600 of a scene cut detection process described in relation to FIGS. 7, 8 and 9.

All or some of the algorithms and steps of these processes may be implemented in software form by the execution of a set of instructions by a programmable machine such as a DSP (digital signal processor) or a microcontroller, or be implemented in hardware form by a machine or a dedicated component such as a FPGA (field-programmable gate array) or an ASIC (application-specific integrated circuit). The processor 600, a DSP, a microcontroller, a FPGA and an ASIC are therefore examples of electronic circuitry adapted to implement the processes described in relation to FIGS. 7, 8 and 9.

FIG. 6C illustrates a block diagram of an example of the system 15 in which various aspects and embodiments are implemented.

System 53 can be embodied as a device including various components or modules and is configured to receive a decoded video content in a first color gamut (or the second format) and to generate a video content in a second color gamut (or in the first format). Examples of such system include, but are not limited to, various electronic systems such as a personal computer, a laptop computer, a smartphone, a tablet or a set top box. Components of the system 53, singly or in combination, can be embodied in a single integrated circuit (IC), multiple ICs, and/or discrete components. For example, in at least one embodiment, the system 53 comprises one processing module 60 that implements a scene cut detection process. In various embodiments, the system 53 is communicatively coupled to one or more other systems, or other electronic devices, via, for example, a communications bus or through dedicated input and/or output ports.

The input to the processing module 60 can be provided through various input modules as indicated in block 62. Such input modules include, but are not limited to, (i) a radio frequency (RF) module that receives an RF signal transmitted, for example, over the air by a broadcaster, (ii) a component (COMP) input module (or a set of COMP input modules), (iii) a Universal Serial Bus (USB) input module, and/or (iv) a High Definition Multimedia Interface (HDMI) input module. Other examples, not shown in FIG. 6C, include composite video.

In various embodiments, the input modules of block 62 have associated respective input processing elements as known in the art. For example, the RF module can be associated with elements suitable for (i) selecting a desired frequency (also referred to as selecting a signal, or band-limiting a signal to a band of frequencies), (ii) down-converting the selected signal, (iii) band-limiting again to a narrower band of frequencies to select (for example) a signal frequency band which can be referred to as a channel in certain embodiments, (iv) demodulating the down-converted and band-limited signal, (v) performing error correction, and (vi) demultiplexing to select the desired stream of data packets. The RF module of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, down-converting the received signal to a lower frequency (for example, an intermediate frequency or a near-baseband frequency) or to baseband. Various embodiments rearrange the order of the above-described (and other) elements, remove some of these elements, and/or add other elements performing similar or different functions. Adding elements can include inserting elements in between existing elements, such as, for example, inserting amplifiers and an analog-to-digital converter. In various embodiments, the RF module includes an antenna.

Additionally, the USB and/or HDMI modules can include respective interface processors for connecting the system 53 to other electronic devices across USB and/or HDMI connections. It is to be understood that various aspects of input processing, for example, Reed-Solomon error correction, can be implemented, for example, within a separate input processing IC or within the processing module 60 as necessary.

Similarly, aspects of USB or HDMI interface processing can be implemented within separate interface ICs or within the processing module 60 as necessary. The demodulated, error corrected, and demultiplexed stream is provided to the processing module 60.

Various elements of the system 53 can be provided within an integrated housing. Within the integrated housing, the various elements can be interconnected and transmit data therebetween using suitable connection arrangements, for example, an internal bus as known in the art, including the Inter-IC (12C) bus, wiring, and printed circuit boards. For example, in the system 53, the processing module 60 is interconnected to other elements of the system 53 by the bus 605.

The communication interface 604 of the processing module 60 allows the system 53 to communicate on the communication network 61. The communication network 61 can be implemented, for example, within a wired and/or a wireless medium.

Data is streamed, or otherwise provided, to the system 53, in various embodiments, using a wireless network such as a Wi-Fi network, for example IEEE 802.11 (IEEE refers to the Institute of Electrical and Electronics Engineers). The Wi-Fi signal of these embodiments is received over the communications network 61 and the communications interface 604 which are adapted for Wi-Fi communications. The communications network 61 of these embodiments is typically connected to an access point or router that provides access to external networks including the Internet for allowing streaming applications and other over-the-top communications. Still other embodiments provide streamed data to the system 53 using the RF connection of the input block 62. As indicated above, various embodiments provide data in a non-streaming manner, for example, when the system 53 is a smartphone or a tablet. Additionally, various embodiments use wireless networks other than Wi-Fi, for example a cellular network or a Bluetooth network.

The system 53 can provide an output signal to various output devices using the communication network 61 or the bus 605. For example, the system 53 can provide a post-processed reconstructed video content to the display system 55.

The system 53 can provide an output signal to various output devices, including the display system 55, speakers 66, and other peripheral devices 67. The display system 55 can include one or more of, for example, a touchscreen display, an organic light-emitting diode (OLED) display, a curved display, and/or a foldable display. The display system 55 can be for a television, a tablet, a laptop, a smartphone (mobile phone), or other devices. The display system 55 can also be integrated with other components (for example, as in a smartphone or a tablet), or separate (for example, an external monitor for a laptop). The other peripheral devices 67 include, in various examples of embodiments, one or more of a stand-alone digital video disc (or digital versatile disc) (DVR, for both terms), a disk player, a stereo system, and/or a lighting system. Various embodiments use one or more peripheral devices 67 that provide a function based on the output of the system 53. For example, a disk player performs the function of playing the output of the system 53.

In various embodiments, control signals are communicated between the system 53 and the display system 55, speakers 66, or other peripheral devices 67 using signaling such as AV.Link, Consumer Electronics Control (CEC), or other communications protocols that enable device-to-device control with or without user intervention. The output devices can be communicatively coupled to the display system 55 via dedicated connections through respective interfaces. Alternatively, the output devices can be connected to the system 53 using the communication network 61 via the communication interface 604. The display system 55 and speakers 66 can be integrated in a single unit with the other components of the system 53 in an electronic device such as, for example, a television. In various embodiments, the display interface includes a display driver, such as, for example, a timing controller (T Con) chip.

The display system 55 and speakers 66 can alternatively be separate from one or more of the other components, for example, if the RF module of input block 62 is part of a separate set-top box. In various embodiments in which the display system 55 and speakers 66 are external components, the output signal can be provided via dedicated output connections, including, for example, HDMI ports, USB ports, or COMP outputs.

FIG. 6B illustrates a block diagram of an example of the system 51 adapted to provide video data to the system 53.

System 51 can be embodied as a device including the various components and modules described above and is configured to perform one or more of the aspects and embodiments described in this document.

Examples of such devices include, but are not limited to, various electronic devices such as personal computers, laptop computers, a camera, a smartphone and a server. Elements or modules of the system 51, singly or in combination, can be embodied in a single integrated circuit (IC), multiple ICs, and/or discrete components.

In various embodiments, the system 51 is communicatively coupled to one or more other systems, or other electronic devices, via, for example, a communications bus or through dedicated input and/or output ports.

The input to the processing module 60 can be provided through various input modules as indicated in block 62 already described in relation to FIG. 6C.

Various elements of the system 51 can be provided within an integrated housing. Within the integrated housing, the various elements can be interconnected and transmit data therebetween using suitable connection arrangements, for example, an internal bus as known in the art, including the Inter-IC (12C) bus, wiring, and printed circuit boards.

For example, in the system 51, the processing module 60 is interconnected to other elements of the system 51 by the bus 605.

The communication interface 604 of the processing module 60 allows the system 51 to communicate on the communication network 61. The communication network 61 can be implemented, for example, within a wired and/or a wireless medium.

Data is streamed, or otherwise provided, to the system 51, in various embodiments, using a wireless network such as a Wi-Fi network, for example IEEE 802.11 (IEEE refers to the Institute of Electrical and Electronics Engineers). The Wi-Fi signal of these embodiments is received over the communications network 61 and the communications interface 604 which are adapted for Wi-Fi communications. The communications network 61 of these embodiments is typically connected to an access point or router that provides access to external networks including the Internet for allowing streaming applications and other over-the-top communications. Still other embodiments provide streamed data to the system 51 using the RF connection of the input block 62. As indicated above, various embodiments provide data in a non-streaming manner.

When a figure is presented as a flow diagram, it should be understood that it also provides a block diagram of a corresponding apparatus. Similarly, when a figure is presented as a block diagram, it should be understood that it also provides a flow diagram of a corresponding method/process.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented, for example, in a processor, which refers to processing devices in general, including, for example, a computer, a microprocessor, an integrated circuit, or a programmable logic device. Processors also include communication devices, such as, for example, computers, smartphones (cell phones), portable/personal digital assistants (“PDAs”), tablets, and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information can include one or more of, for example, estimating the information, calculating the information, predicting the information, retrieving the information from memory or obtaining the information for example from another device, module or from user.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, “one or more of” for example, in the cases of “A/B”, “A and/or B” and “at least one of A and B”, “one or more of A and B” is intended to encompass the selection of the first listed option (A) only, or the selection of the second listed option (B) only, or the selection of both options (A and B). As a further example, in the cases of “A, B, and/or C” and “at least one of A, B, and C”, “one or more of A, B and C” such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

As will be evident to one of ordinary skill in the art, implementations or embodiments can produce a variety of signals formatted to carry information that can be, for example, stored or transmitted. The information can include, for example, instructions for performing a method, or data produced by one of the described implementations or embodiments. For example, a signal can be formatted to carry a post-processed reconstructed video content. Such a signal can be formatted, for example, as an electromagnetic wave (for example, using a radio frequency portion of spectrum) or as a baseband signal. The information that the signal carries can be, for example, analog or digital information. The signal can be transmitted over a variety of different wired or wireless links, as is known. The signal can be stored on a processor-readable medium.

FIG. 7 illustrates schematically a method for identifying a scene cut in a video. The method of FIG. 7 is executed for example by the processing module 60 of the system 53. Additionally, the processing module 60 of the system 53 implements for example a post-processing process applied on the video and depending on the detection of scene cuts. For instance, post-processing parameters are updated at each scene cut.

In a step 700, the processing module 60 obtains two consecutive pictures of a video sequence.

In a step 701, the processing module 60 computes (i.e. calculates) a first histogram of a first of the two pictures and a second histogram of a second of the two pictures.

In a step 702, the processing module 60 computes a first information, the first information, called Evidence 1 in the following, being a number of bins for which an absolute value of a difference between a first value representative of a number of samples represented by a bin of the first histogram and a second value representative of a number of samples represented by a corresponding bin of the second histogram each compared bin having the same size in both histograms) is higher than a third value, as follows:

The computation of the first information Evidence 1 during step 702 is illustrated in FIG. 8.

In a step 7021, the processing module 60 initialize the first information Evidence 1 to zero and a variable i to zero.

In a step 7022, the processing module 60 computes the absolute value of the difference between the first value representative of the number of samples represented by the bin i of the first histogram and the second value representative of the number of samples represented by the bin i of the second histogram:

$$\vert histo 1 [ i ] - histo 2 [ i ] \vert$$

Where histo1[i] and histo2[i] represent respectively the number of samples represented by the bin i of the first histogram and the second value representative of the number of samples represented by the bin i of the second histogram (both bins having the same size).

During step 7022, the processing module 60 compares the computed absolute value of the difference to the third value TH1. In the example of FIG. 7, we consider that the histograms histo1 and histo2 are normalized histograms comprising “256” bins. In that case, it has been observed that a threshold TH1 equal to “0.001” allows eliminating all the bins which are quite constant. One can note that other values of TH1 can be used. Therefore, in an embodiment of step 7022, as an example, the third value TH1 is fixed and set to “0.001”. In another embodiment of step 7022, the third value TH1 is variable and depends on the luminance value corresponding to the bin i (i.e. depends on the variable i). For example, in the case where the pictures are noisy, TH1 can be increased for the low levels in order to be less sensible to the embedded noise.

If at step 7022 |histo1 [i]-histo2 [i]|>TH1, step 7022 is followed by a step 7023. During step 7023, the processing module 60 increments the first information Evidence1 of one unit. Step 7023 is followed by a step 7024. If |histo1 [i]-histo2 [i]|≤TH1, step 7022 is followed by step 7024.

During step 7024, the processing module 60 increments the variable i of one unit.

In a step 7025, the processing module 60 compares the variable i to a number of bins in the histograms NbBin (here NbBin=256). If i<NbBin, step 7025 is followed by step 7022. Otherwise, the process of FIG. 8 ends in a step 7026.

In a step 703, the processing module 60 performs compares the first information Evidence 1 to a fourth value TH2. In an embodiment of step 703 the fourth value TH2 is fixed and equal for example to “10” or “40”. One can note that TH2 depends on the number of bins in the histogram.

If Evidence1>TH2, the processing module 60 identifies a scene cut between the two pictures in a step 705. Otherwise, a final decision on the eventual presence of a scene cut is taken by the processing module 60 in a step 706. In a first embodiment of step 706, the processing module 60 determines that there is no scene cut between the two pictures.

As an example, the method of FIG. 7 is applied to the situation represented by FIG. 1 in which there is no scene cut and FIG. 2 in which there is a scene cut.

In case of FIG. 1, Evidence1=0 while the Bhattacharyya distance gives “0.009568”. In case of FIG. 2, Evidence 1=201, while the Bhattacharyya distance gives 0.633111.

On these two results, supposing that the detection threshold for the Bhattacharyya distance is 0.1, the method of FIG. 7 and the Bhattacharyya distance gives the same result: no scene cut is detected in the case of FIG. 1 while a scene cut is detected in the case of FIG. 2.

In the example of FIGS. 3 and 4, a false scene cut is detected using the Bhattacharyya distance (=0.324149). However, in this case Evidence1=4, which is under the threshold TH2 (=40 for example) used to trigger the cut detection. The method of FIG. 7 better distinguished between real and false scene cuts.

In a second embodiment of the method of FIG. 7, the first value representative of the number of samples represented by the bin i of the first histogram is a result of an application of a non-linear function to the number of samples represented by the bin i of the first histogram. Similarly, the second value representative of the number of samples represented by the bin i of the second histogram is a result of an application of the same non-linear function to the number of samples represented by the bin i of the second histogram. For example, a non-linear function of x ƒ(x) is \sqrt{x} or ³\sqrt{x}. For example, in step 7022, the processing module 60 compares a new metric |ƒ(histo1 [i])−ƒ(histo2 [i])| with ƒ(x)=\sqrt{x} to the third value TH1. In that case, the value of the third value TH1 is adapted to the new metric. For example, TH1 is fixed and equal “0.01”. In a variant, again TH1 is variable and depends on the luminance value corresponding to the bin i (i.e. depends on the variable i).

In the second embodiment of the method of FIG. 7, the processing module 60 implements a new step 704 between steps 703 and 705 (or 706).

In step 704, the processing module 60 computes a second information Evidence2 as a sum of the differences ƒ(histo1 [i])−ƒ(histo2 [i]) for which the absolute value of the difference is higher than the third value TH1. Then, in step 704, the processing module 60 compares the second information Evidence 2 to a fifth value TH3.

If Evidence 2>TH3, the processing module 60 considers that it has identified a scene cut between the two pictures in step 705. Otherwise, step 704 is followed by step 706.

In the second embodiment of the method of FIG. 7 TH2 is for example set to “40” and TH3 is set to “0.5”.

As an example, the second embodiment of the method of FIG. 7 is applied to the situation represented by FIG. 1 in which there is no scene cut and FIG. 2 in which there is a scene cut. In case of FIG. 1, Evidence 1=0 and Evidence2=0 (The Bhattacharyya distance gives “0.009568”). In case of FIG. 2: Evidence 1=215, Evidence 2=1.487326 (The Bhattacharyya distance gives 0.633111). Again, the second embodiment of the method of FIG. 7 and the Bhattacharyya distance gives the same result: no scene cut is detected in the case of FIG. 1 while a scene cut is detected in the case of FIG. 2.

In the case of the example of FIGS. 3 and 4, again the Bhattacharyya distance (=0.324149) identifies a scene cut while. The second embodiment of the method of FIG. 7 with Evidence 1=4 (which is lower than TH2) and Evidence 2=0.016747 (which is lower than TH3) does not identify a scene cut.

The comparisons Evidence1> TH2 and Evidence2>TH3 can be viewed as two independent evidences of a presence of a scene cut between the two successive pictures. An uncertainty may occur when Evidence1≤TH2 and Evidence2>TH3 or when Evidence1>TH2 and Evidence 2≤TH3 since, in these cases, the two evidences provide contradictory results.

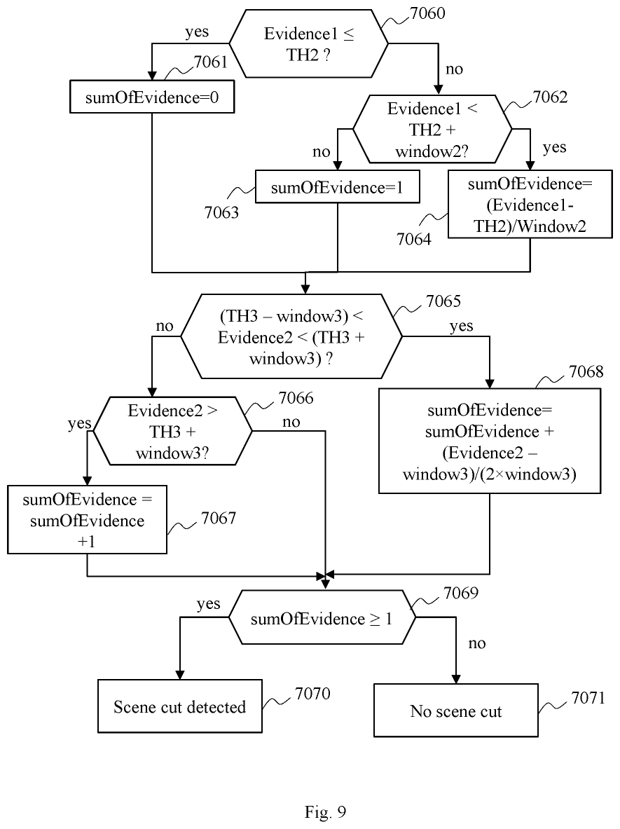

FIG. 9 illustrates a variant of the method of FIG. 7 dealing with such uncertain cases.

The process described in relation to FIG. 9 is executed during step 706 when Evidence 1≤TH2 and Evidence2>TH3 or when Evidence1>TH2 and Evidence2≤TH3.

In a step 7060, the processing module 60 compares the first information Evidence 1 to the fourth value TH2. If Evidence 1≤TH2, step 7060 is followed by a step 7061. Otherwise, the 7060 is followed by step 7062.

In step 7061, the processing module 60 sets a variable sumOfEvidence to zero.

In step 7062, the processing module 60 determines if Evidence1 is less than (TH2+window 2) where for example window2=TH2/2. Responsive to Evidence1<TH2+window2, the processing module 60 sets the variable sumOfEvidence to ((Evidence 1-TH2)/Window2) in a step 7064. Otherwise, in a step 7063, the processing module 60 sets the variable sumOfEvidence to “1”.

Steps 7061, 7063 and 7064 are followed by a step 7065.

In step 7065, the processing module 60 determines if Evidence2 is such that (TH3-window 3)<Evidence2< (TH3+window 3). If (TH3-window3)<Evidence 2< (TH3+window3) (where window 3 is for example equal to TH3/2) is not verified, step 7065 is followed by a step 7066.

During step 7066, the processing module 60 determines if Evidence2>TH3+window3. If yes, step 7066 is followed by a step 7067 during which the variable sumOfEvidence is incremented of one unit. Otherwise, step 7066 is followed by a step 7069. Step 7067 is also followed by step 7069.

If the condition (TH3-window 3)<Evidence2< (TH3+window 3) is verified in step 7065, step 7065 is followed by a step 7068.

In step 7068, the processing module 60 computes a new value of the variable sumOfEvidence as follows:

$$sumOfEvidence = sumOfEvidence + ( Evidence 2 - window 3 ) / ( 2 \times window 3 )$$

Step/068 is followed by step/069.

In step 7069, the processing module determines if the variable sumOfEvidence is higher than or equal to one. If yes, the processing module 60 identified a scene cut in a step 7070. Otherwise, no scene cut is detected between the two consecutive pictures in a step 7071.

One can note that, in an embodiment, values TH1, TH2 and TH3 had been determined using a large set of video sequences. In addition, the process of FIG. 9 can be viewed as a confirmation process based on a comparison of Evidence1 with a confidence range around TH2 defined using window 2 and a comparison of Evidence 2 with a confidence range around TH3 defined using window 3.

We described above a number of embodiments. Features of these embodiments can be provided alone or in any combination. Further, embodiments can include one or more of the following features, devices, or aspects, alone or in any combination, across various claim categories and types:
A bitstream or signal that includes one or more of the described video content or variations thereof.
Creating and/or transmitting and/or receiving and/or decoding a bitstream or signal that includes one or more of the described video content, or variations thereof.
A TV, set-top box, cell phone, tablet, personal computer or other electronic device that performs at least one of the embodiments described, and that displays (e.g. using a monitor, screen, or other type of display) a resulting picture.
A TV, set-top box, cell phone, tablet, personal computer or other electronic device that tunes (e.g. using a tuner) a channel to receive a signal including a reconstructed video content, and performs at least one of the embodiments described.
A TV, set-top box, cell phone, tablet, or other electronic device that receives (e.g. using an antenna) a signal over the air that includes a reconstructed video content, and performs at least one of the embodiments described.

1. A method comprising:
obtaining two consecutive pictures of a video sequence;
computing a first histogram of a first of the two consecutive pictures and a second histogram of a second of the two consecutive pictures;
computing a first information, the first information being a number of bins for which an absolute value of a difference between a first value representative of a number of samples represented by a bin of the first histogram and a second value representative of a number of samples represented by a corresponding bin of the second histogram is higher than a third value, each value representative of a number of samples is a non-linear function of the number of samples;
performing a first comparison comparing the first information to a fourth value;
computing a second information as a sum of the differences for which the absolute value of the difference is higher than the third value and performing a second comparison comparing the second information to a fifth value; and
identifying a scene cut between the two consecutive pictures in function of a result of the first comparison and a result of the second comparison.

2-3. (canceled)

4. The method of claim 1, wherein, responsive to one of the first and second comparison indicates a scene cut while the other one of the first and second comparison indicates no scene cut, a confirmation process based on a third comparison comparing the first information to a confidence range around the fourth value and on a fourth comparison comparing the second information to a confidence range around the fifth value is applied to confirm a presence of a scene cut.

5. A device comprising electronic circuitry configured for:
obtaining two consecutive pictures of a video sequence;
computing a first histogram of a first of the two consecutive pictures and a second histogram of a second of the two consecutive pictures;
computing a first information, the first information being a number of bins for which an absolute value of a difference between a first value representative of a number of samples represented by a bin of the first histogram and a second value representative of a number of samples represented by a corresponding bin of the second histogram is higher than a third value, each value representative of a number of samples is a non-linear function of the number of samples;
performing a first comparison comparing the first information to a fourth value;
computing a second information as a sum of the differences for which the absolute value of the difference is higher than the third value and performing a second comparison comparing the second information to a fifth value; and
identifying a scene cut between the two consecutive pictures in function of a result of the first comparison and a result of the second comparison.

6-7. (canceled)

8. The device of claim 5, wherein, responsive to one of the first and second comparison indicates a scene cut while the other one of the first and second comparison indicates no scene cut, the electronic circuitry is further configured to apply a confirmation process based on a third comparison comparing the first information to a confidence range around the fourth value and on a fourth comparison comparing the second information to a confidence range around the fifth value to confirm a presence of a scene cut.

9. Non-transitory information storage medium storing program code instructions for implementing the method according to claim 1.

10. Non-transitory information storage medium storing program code instructions for implementing the method according to claim 2.
